(19) United States
(12) Patent Application Publication
(10) Pub. No.: US 2008/0296917 A1
(43) Pub. Date: Dec. 4, 2008

(54) Locking Device For Sliding Panel, Corresponding Closure And Motor Vehicle

(75) Inventors: Frederic Giret, Bressuire (FR); Stephane Moreau, Le Temple (FR); Regis Leboeuf, Les Landes Genusson (FR)

Correspondence Address: SHEWCHUK IP SERVICES, 3356 SHERMAN CT. STE. 102, EAGAN, MN, 55121, US

(73) Assignee: WAGON SAS, Bressuire (FR)

(21) Appl. No.: 11/754,867

(22) Filed: May 29, 2007

(51) Int. Cl. E05B 57/00

(52) U.S. Cl. 292/341.17

(57) ABSTRACT

A device for locking a sliding panel of a motor vehicle, which panel is mobile with respect to a stationary structure, including means for actioning of bolt(s), which are mobile with respect to said sliding panel and capable of adopting at least three positions:
a resting position, in which said bolt(s) is (are) in a locked state with one of said complementary locking elements; and
two unlocking positions, called left and right, in which said unlocking positions implement transmission means acting on said bolt(s), which are mounted symmetrically with respect to an axis perpendicular to the sliding axis of said sliding panel, so as to create similar actions on said bolt(s) in each of said locking positions, and to allow, in the same movement of a user:
the change from the resting position to one of said unlocked positions;
the sliding movement of said mobile panel in one or the other sliding directions, called right and left, according to the locking position selected.

This invention relates to motor vehicle windows. More specifically, the invention relates to devices for closing a window provided in the body of a vehicle, or in a door of the vehicle, and including a sliding mobile portion, capable of opening or closing an opening provided in these devices.

Conventionally, to close a window of a vehicle, whether it is an automobile, a utility vehicle, a truck, a bus or a railroad car, a glazing held by a junction frame is provided. The junction frame has an internal portion and an external portion, which simultaneously pinch the edges of the glass plate and the opening provided in the body, with a lining seal.

The most widely used technique for opening and closing door windows is to make them vertically mobile in their own plane, by causing them to enter or leave the casing or lining of the door. Panels that slide horizontally along rails formed in a frame are also known.

Another technique has been proposed by the holder of this patent application. This technique is described in particular in the patent documents EP 0 778 168 and EP 0 857 844. The closure (hereinafter called a “flush window”) presented in these documents includes a stationary assembly and a portion that is mobile with respect to said stationary assembly. The mobile portion is connected to the stationary assembly by functional elements that ensure the required mobility and that are provided on the side of the stationary portion turned toward the inside of the vehicle.

Such a “flush” window can be integrally mounted independently of the vehicle, and provided, from the outside, in the housing defined for this purpose in the vehicle body. It can also be integrated, in particular by bonding to the lower portion of a door, according to the technique described in patent document EP 1 022 172.

Aesthetically, the “flush” window has, when seen from the outside, a smooth appearance, flush with the body, because no frame is necessary.

To enable the mobile portion, generally constituted by a transparent panel, to slide, a guide device, for example, comprising a first and a second guide rails mounted stationarily on the stationary window assembly (or stationary structure), on each side of the opening closed by the mobile panel. It is mounted on the rails, so as to slide, for example, in a longitudinal direction, in a sliding plane between one (or more) open positions and an intermediate disengaged position in which it is opposite the window and disengaged therefrom.

The invention relates more specifically to this type of closure called a “flush window”, its alternatives and its improvements. However, the invention can more broadly be applied to all closures of which the opening and/or closing kinematics include a movement (y plane) between an open position and an intermediate disengaged position, in a plane parallel to the plane of the stationary assembly, and a movement (x plane) in this parallel plane.

A number of solutions have been proposed for the locking of the mobile panel in the closed position, and, as the case may be, in chosen open positions. They are usually not very ergonomic nor practical, and require in particular a force, for example a clamping force, in order to achieve the locking.

Among these, is a technique presented in document EP 1 659 247, in which at least one bolt is provided, cooperating with a strike formed in one of the support and/or guide elements, which strike has at least one ramp, so that the switching from a locked position to an unlocked position of the locking means causes the mobile panel to move from a first plane to a second plane, and the reverse. Two bolts can be provided, in order to effectively lock the mobile panel in the top and bottom portions.

This approach is functionally effective. However, it is not very ergonomic, since the movement of the bolt is perpendicular to the sliding axis, which involves difficult manipulations. This is all the more true if two bolts are provided.

The invention is intended in particular to overcome these disadvantages of the prior art.

More specifically, the invention is designed to propose a device for locking a sliding panel of a window, simplifying the operations of opening and closing of said panel, and the locking thereof in the closed position, and, as the case may be, in the open position.

The invention is also intended to provide such a window closure that allows for effortless locking, unlocking and reliable sliding.

Thus, a specific objective of the invention is to provide such a device, which makes it possible to easily control the sliding of the mobile panel, regardless of the direction of movement (opening or closing).

The invention is also designed to provide such a window closure that is simple to produce, and to mount on a door or a vehicle.

Another objective of the invention is to provide such a window closure device that has all of the advantages of “flush windows” already established by the holder of this application, in particular:

a flush appearance;

aerodynamic aspects;

ease and reduced cost of production;

ease and reduced cost of assembly.

These objectives, as well as others, which will appear below, are achieved by a device for locking a sliding panel of a motor vehicle, which panel is mobile with respect to a stationary structure, which device includes at least one bolt cooperating with at least one complementary locking element provided for this purpose on said stationary structure, and capable of moving along a locking axis so as to go from an unlocked state enabling said sliding panel to slide to a locked state in which it cooperates with one of said complementary locking elements so as to prevent said sliding, and vice versa.

The invention includes means for manual actioning of said bolt(s), which are mobile with respect to said sliding panel and capable of adopting at least three positions:

a resting position, in which said bolt(s) is (are) in a locked state with one of said complementary locking elements; and

two unlocking positions, called left and right, in which said unlocking positions implement transmission means acting on said bolt(s), which are mounted symmetrically with respect to an axis perpendicular to the sliding axis of said sliding panel, so as to create similar actions on said bolt(s) in each of said locking positions, and to allow, in the same movement of a user:

a change from the resting position to one of said unlocked positions;

the sliding movement of said mobile panel in one or the other sliding directions, called right and left, according to the locking position selected.

It is thus possible to simply and effectively control the movement of the mobile panel, in both sliding directions. Whether the mobile panel is to be moved in one direction or the other, it is simply necessary to act on the actuation means, then, without releasing them, move the panel in the desired direction.

According to a first embodiment of the invention, such a device includes a button for actuating said bolt(s), which is capable of moving in rotation with respect to said sliding panel, along an axis substantially perpendicular to the plane defined by said sliding panel, and capable of adopting at least two positions:

a resting position, in which said bolt(s) is (are) in a locked state with one of said complementary locking elements; and

two unlocking positions, called left and right, corresponding to a rotation by a predetermined angle with respect to said resting position, respectively in one or the other directions of rotation,

wherein said unlocking positions correspond to similar actions on said bolt(s).

Thus, a simple and effective system is obtained, allowing the panel to be unlocked, then to slide, in a single manoeuvre of the actuation button.

It is possible to unlock the system in two opposite directions, and therefore to cause the panel to slide both to the left and to the right. Of course, this “left/right” terminology must be understood here to mean “in both directions”, and the sliding can also be vertical, and more generally in any direction and any plane.

According to an advantageous embodiment, said actuation button cooperates with transmission means acting on said bolt(s) and including two connection elements for each of said bolts, wherein a first of said connection elements is active in said left unlocking position, and a second of said connection elements is active in said right unlocking position.

These two connection elements thus make it possible to have a perfectly symmetrical operation.

Advantageously, said actuation means include at least one cam actuated by said actuation button and acting on said connection elements, by means of at least one hole guiding at least one lug integrated with one of said connection elements.

Said hole(s) can in particular define an arc of a circle. It is possible to have a single arc of a circle, or two arcs of a circle (one for each connection element).

At least one of said cams preferably has, in the vicinity of its periphery, a finger circulating in a hole defined in said actuation button.

Said transmission means can, for example, belong to the group including cables and rods.

According to an advantageous embodiment, said transmission means are connected to said bolt by means for taking up play.

Each of said bolts advantageously cooperates with return means, tending to bring it into said locked state.

In a preferred embodiment of the invention, the device includes two bolts, distributed on each side of said actuation button, and two cams respectively associated with one and the other of said bolts, so that said actuation button acts simultaneously and symmetrically on said bolts.

In this case, said cams are advantageously mounted on the same axis.

According to a second embodiment of the invention, each of said bolts is integrated with transmission, or connection means, extending substantially in the extension of said locking axis, when said bolt is in said locked state, and the device includes at least one unlocking carriage, mobile in translation along an offset axis substantially perpendicular to said locking axis and substantially parallel to the plane defined by said sliding panel, and acting on said connection means so as to offset them and drive said bolt(s) into said unlocked state.

Thus, there is a simple and effective mechanism for ensuring the unlocking, which is capable of functioning in two directions corresponding to the two possible directions for the sliding.

Said transmission means advantageously include at least one cable.

In this case, each of said unlocking carriages preferably includes at least one cable passage, in which said cable(s) can slide. This makes it possible to effectively guide the cable(s).

According to an advantageous embodiment, each of said unlocking carriages is actuated by a finger integrated with a control button.

In this case, said control button can in particular impart a rotation movement on said finger, according to an axis of rotation substantially parallel to said locking axis.

The device preferably includes two unlocking carriages moving in opposite directions. This makes it possible to amplify the movement of the cable(s).

According to a specific embodiment of the invention, the device includes two bolts, distributed on each side of said unlocking carriage(s).

In this case, said connection means advantageously include two parallel cables, each connected to the two bolts or respectively by one end to one of the bolts and by the other end to a stationary element.

The device, and in particular the carriage(s), advantageously include means for distancing said cables from one another so as to prevent any friction between them.

This makes it possible to avoid friction, and therefore excessive wear and malfunctions.

Each of said bolts preferably cooperates with return means, tending to bring them back to said locked state. The handle is thus also returned to a resting position corresponding to the locked state.

According to a third embodiment, each of said bolts is integrated with a first end of a cable, of which the second end is integrated with a driven gear, driven by a driving gear so as to move said bolt(s) from said locked state to said unlocked state, said driving wheel being actuated by an actuation button.

By “gear” in this case, we mean a gear element, such as a wheel or a wheel portion.

Thus, according to this embodiment, we have a simple, reliable and effective system making it possible in a single movement to unlock the panel and move it by sliding indifferently in one or the other of the sliding directions.

Said driving gear is advantageously actuated by at least one finger integrated with said actuation button.

In this case, according to a specific embodiment, said control button can impart a rotation movement on each of said fingers, according to an axis of rotation substantially parallel to said locking axis.

Said actuation button advantageously acts on two fingers moving in opposite directions.

According to an advantageous embodiment of the invention, the device includes two bolts, distributed on each side of the driving gear, each associated with a cable and a driven gear.

The device preferably includes elements for guiding said cable(s), integrated with said stationary structure.

According to an advantageous feature of the invention, each of said bolts cooperates with return means, tending to bring it back to said locked state.

This movement simultaneously brings the entire device, and in particular the actuation button, to a resting position.

The invention also relates to a closure of a motor vehicle window, including at least one panel capable of a sliding movement, which is mobile with respect to a stationary structure implementing a locking device as described above.

The invention also relates to a motor vehicle including at least one such window closure.

Other features and advantages of the invention will become clearer on reading the following description of a preferred embodiment of the invention, given by way of an illustrative and non-limiting example, and drawings in which:

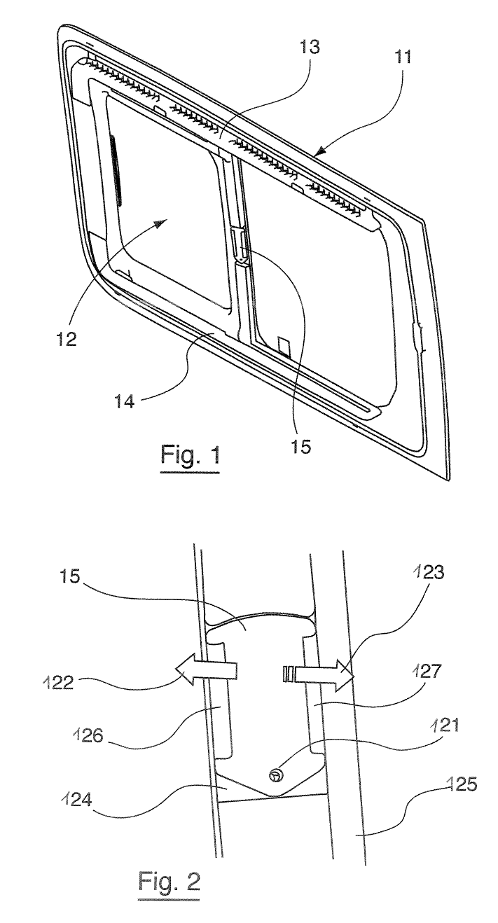

FIG. 1 is a perspective view of a closure according to the invention;

FIG. 2 is an enlarged view of the handle of the panel of FIG. 1 according to a first embodiment;

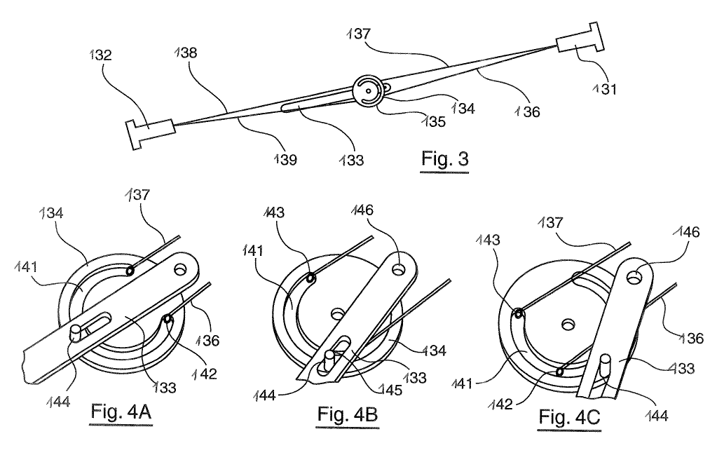

FIG. 3 shows the locking device according to the invention, provided in the closure of FIG. 2;

FIGS. 4A to 4C show the device of FIG. 3 in three positions:

FIG. 4A: locked device;

FIG. 4B: partially unlocked device;

FIG. 4C: unlocked device;

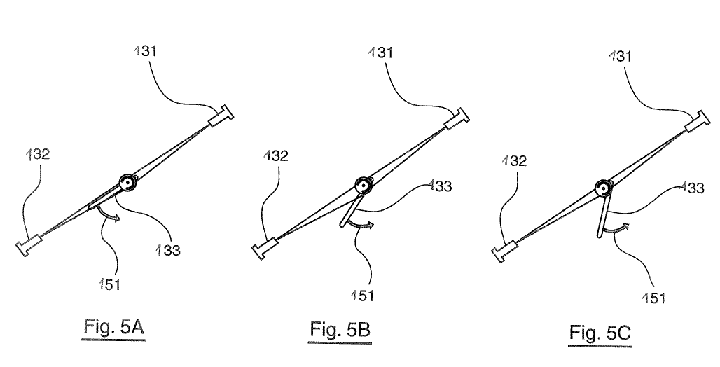

FIGS. 5A to 5C are enlarged views of the cam and a portion of the handle of FIGS. 4A to 4C, respectively;

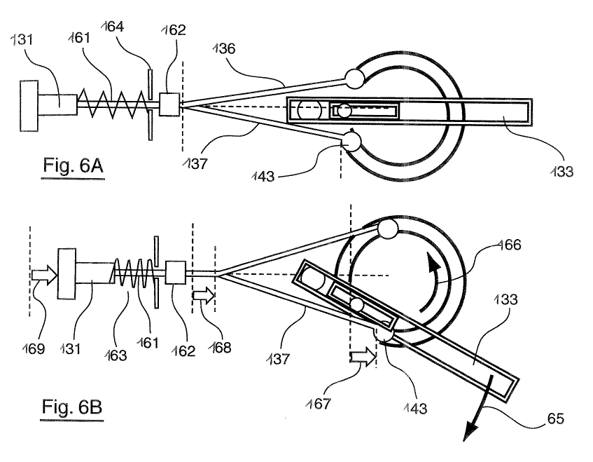

FIGS. 6A and 6B diagrammatically show the principle of operation of a device according to the invention, respectively:

FIG. 6A: locked state;

FIG. 6B: unlocked state;

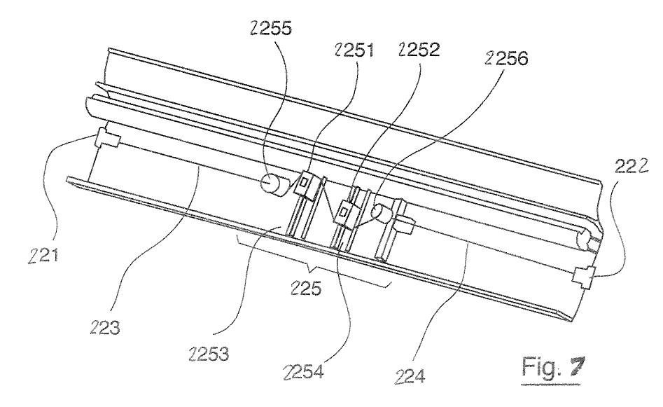

FIG. 7 diagrammatically shows the locking means of the panel of FIG. 1 according to a second embodiment;

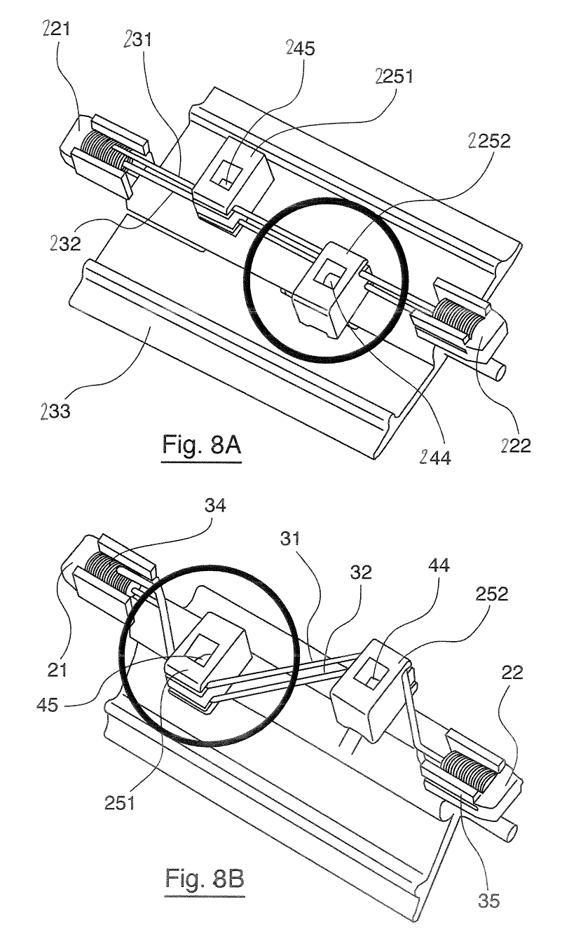

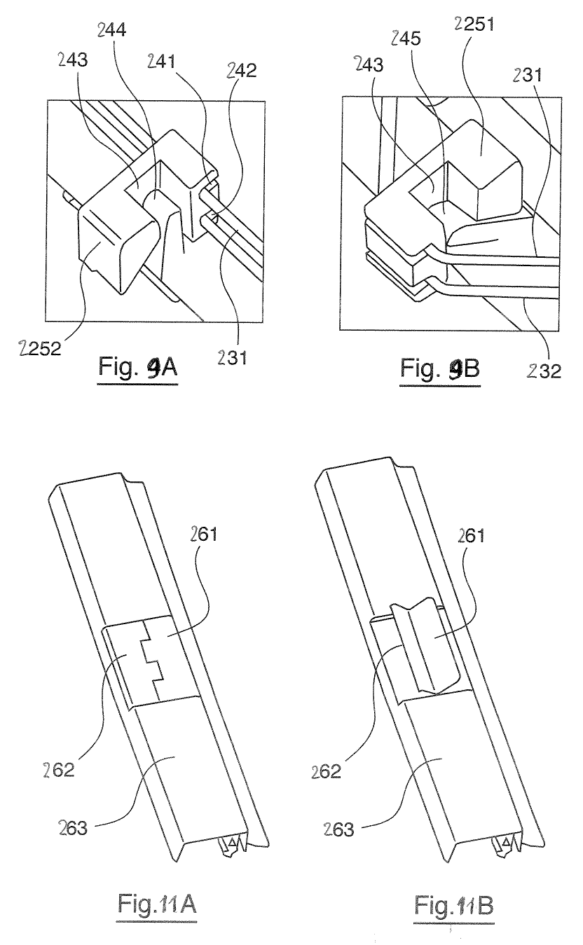

FIGS. 8A and 8B more specifically show the locking/unlocking means of FIG. 7, respectively:

FIG. 8A: locked state;

FIG. 8B: unlocked state;

FIGS. 9A and 9B are enlarged views of a carriage of FIGS. 8A and 3B respectively;

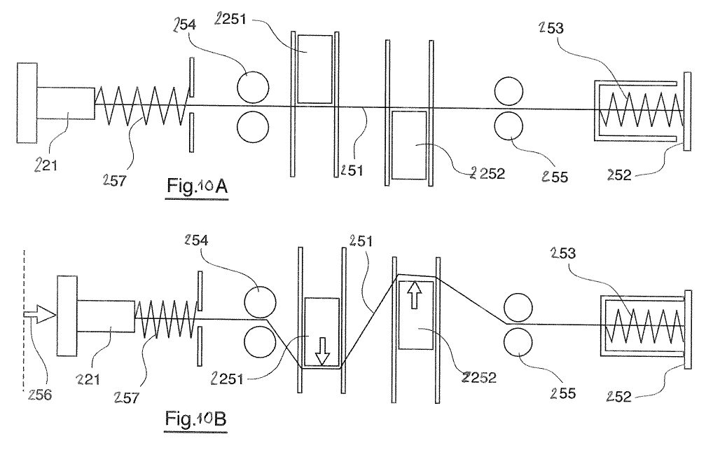

FIGS. 10A and 10B diagrammatically show the principle of operation of the device of FIG. 7, respectively:

FIG. 10A: locked state;

FIG. 10B: unlocked state;

FIGS. 11A and 11B show an example of an actuation button of the device of FIG. 7, respectively:

FIG. 11A: locked state;

FIG. 11B: unlocked state;

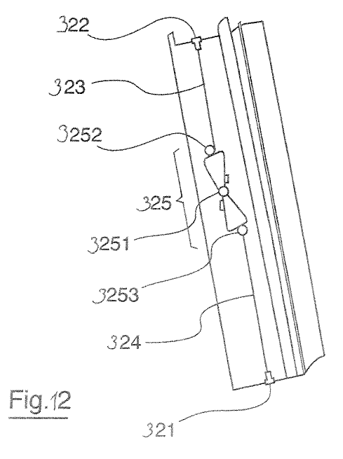

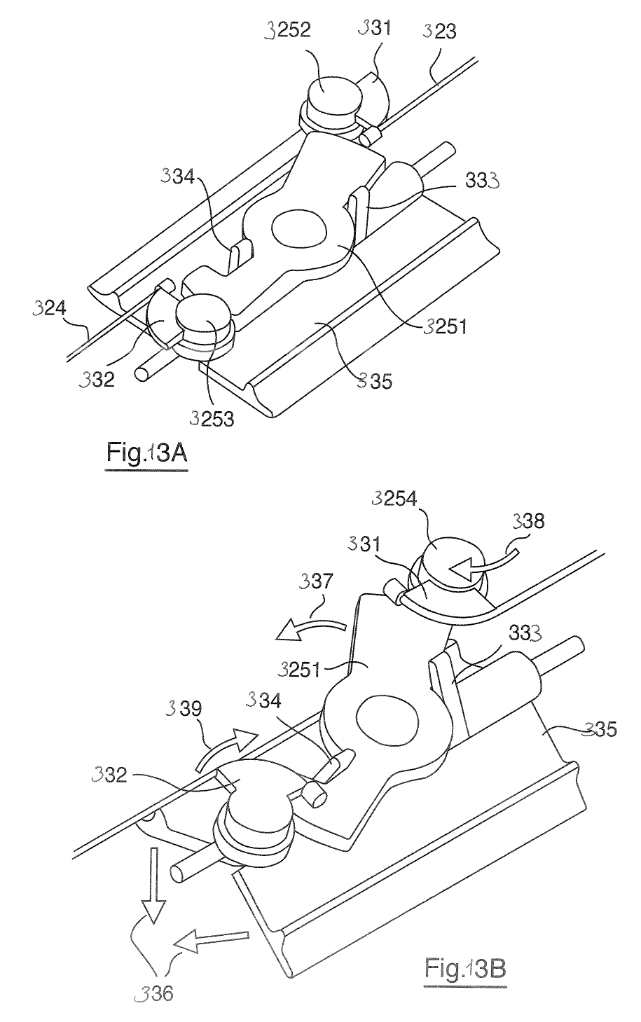

FIG. 12 diagrammatically shows the locking means of the panel of FIG. 1 according to a third embodiment;

FIGS. 13A and 13B more specifically show the locking/unlocking means of FIG. 12, respectively:

FIG. 13A: locked position;

FIG. 13B: unlocked position;

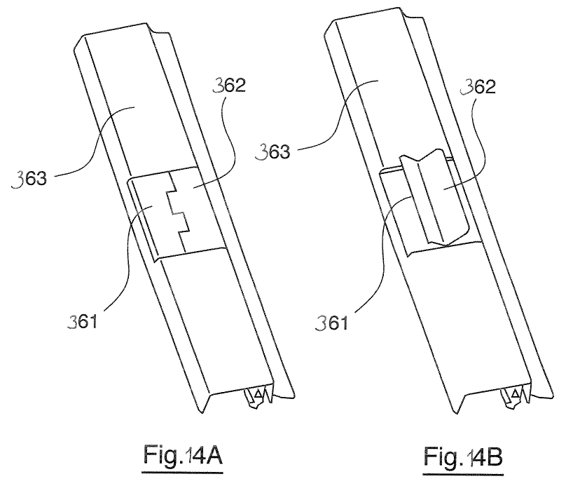

FIGS. 14A and 14B show an example of an actuation button of the device of the invention, respectively:

FIG. 14A: locked state;

FIG. 14B: unlocked state.

As already indicated, the general principle of the invention is based in particular on the implementation of a handle, which can be actuated indifferently in two directions in order to unlock a mobile panel, then move it by sliding it in one direction or the other.

FIG. 1 shows a window closure provided in the body of a vehicle, implementing a locking device according to the invention. It includes a stationary assembly 11 on which a mobile panel 12 is mounted, which is capable of sliding along rails 13 and 14 mounted in upper and lower portions of the stationary assembly 11. These rails are provided on the face of the stationary assembly turned toward the interior of the vehicle.

The mobile panel 12, in this case a glazing, has two bolts cooperating respectively with upper 13 and lower 14 rails. A handle 15 makes it possible to simultaneously control the two bolts, as shown in detail below. Of course, it is also possible to implement the invention with a single bolt, in the upper portion or in the lower portion.

The device is mounted so that the locking/unlocking movement of each bolt occurs in a plane parallel to that of the mobile panel, and in a direction perpendicular to the sliding direction. In the embodiment shown, the panel is capable of moving horizontally and the locking/unlocking movement is vertical.

In the embodiment shown, the locking device of the invention includes two bolts acting respectively in upper and lower portions of the mobile panel 12, so as to cooperate with the rails 13 and 14, either directly, or by means of one or more strikes defined in each rail.

Strikes can be provided in particular for the closed position of the mobile panel, but also to define one or more predetermined open positions. In this case in particular, it is highly advantageous to be capable of moving the panel indifferently in one direction or the other, in order to close it or open it more widely, for example. The approach of the invention then makes it possible, in a single operation on (or a single grip of) the handle, to control the unlocking then the sliding in one direction or the other.

Three embodiments are described below.

### 1. First Embodiment

FIG. 2 more specifically shows the mechanism of the invention, in a particular embodiment. An actuation button (or handle) 15 is mounted so as to be capable of moving in rotation about an axis of rotation 121, and can therefore be turned to the left (122) and to the right (123). Advantageously, a housing 124 is defined in the frame 125 of the mobile panel 12, so that the handle is substantially flush with the rest of the frame.

Numerous designs can be envisaged for this handle, according to needs. It is possible in particular to provide areas 126 and 127 making it easier to grip.

On the other side of the frame, the button acts on two bolts, according to the assembly shown in FIG. 3. The two bolts 131 and 132 are housed in the frame 125 and are mounted so as to cooperate with the rails 113 and 114, respectively. It is possible for the rail to be adapted so as to cooperate with the corresponding bolt in any position, or to have strikes provided for this purpose in a plurality of intermediate locations, or at least in the closed position of the mobile panel.

More specifically, the button 15 acts on a lever, called a hand lever 133, which reproduces the rotation movement and acts on two superimposed cams 134 and 135 (i.e. sharing the same axis).

The cam 134 is connected to the bolt 131 by means of two rods 136 and 137, mounted so as to control the actuation of the bolt depending on whether the handle is moved in one direction or in the other. Symmetrically, the bolt 132 is connected to the cam 135 by two rods 138 and 139.

In another embodiment, these rods can be replaced by other connection means, such as cables.

As shown in FIGS. 4A to 4C, each cam 134 includes a hole in the shape of an arc of a circle 141, in which two lugs 142 and 143 circulate, which lugs are respectively connected to the two rods 136 and 137. At rest, i.e. in the locked position (FIG. 4A), the two lugs 142 and 143 each abut one of the ends of the hole 141.

The cam 134 also has, at its periphery, a finger 144, provided so as to slide in an oblong hole 145, formed in the hand lever 133.

As seen in FIGS. 4B and 4C, when the hand lever 133 is moved by rotation about its axis 146, the hole 145 moves the finger 144 and drives the cam 134 in rotation. The lug 143 is then drawn by the hole 141. Consequently, the rod 137 draws the bolt 131. At the endstop (FIG. 4C), the bolt 131 is unlocked, i.e. it released from the strike and/or the rail.

It is noted that the second lug 142 moves into the hole 141, but remains inactive. Of course, when the handle is moved in the other direction, it is this lug 142 that acts identically, by means of the rod 136.

FIGS. 5A to 5C show the progressive unlocking of the bolts 131 and 132 as the hand lever 133 is moved (arrow 51).

FIGS. 6A and 6B show this principle of operation more diagrammatically. These figures show the actuation of a single bolt 131. Indeed, as already indicated, the mechanism of the invention can be implemented so as to control the operation of a single bolt or two bolts distributed on each side of the handle, for example in upper and lower portions of the panel.

The bolt 131 is therefore connected to the rods 136 and 137, by means of a part 161 that has means for taking up play 162 and a return spring 163, coming into contact with the bolt 131 and with a stationary stop element 164 provided for this purpose on the window frame. This spring 163 is compressed when the bolt is in the unlocked position (FIG. 6B) and therefore tends to return the bolt to the locked position (FIG. 6A) when no action is applied on the hand lever 133.

When this lever 133 is moved by the user (arrow 165), the lug 143 is driven by the hole 141, with the cam moving in the direction of the arrow 166. The movement 167 of the lug 143 is maintained at the other end of the rod 137 (arrow 168) and consequently at the level of the bolt (arrow 169), which ensures the unlocking.

It clearly appears in these figures that the movement is symmetrical, and that the same effect is obtained by moving the handle in the other direction.

When the user releases the handle, the return spring 163 tends to return the bolt 131 to the locked position (FIG. 6A). The means for taking up play 163 act on the two rods 136 and 137 so as to return them to their initial positions, which causes the handle to return to its original position (vertical in the example described).

### 2. Second Embodiment

As shown in FIG. 7, which shows a portion of the frame of the mobile panel, bearing the locking device, the two bolts 221 and 222 are connected by at least one cable 223, 224 to the unlocking means 225, which include two carriages 251, 252 mounted so as to be capable of moving in translation on guide rails provided for this purpose 253, 254. The translation axis defined by these rails 253 and 254 is perpendicular to the axis passing through the two bolts 221, 222. Thus, the movement of two carriages 2251, 2252 drive the cable(s) 223, 224 according to a baffle effect, when they are moved, which tends to pull on the cables and consequently unlock the bolts 221 and 222.

Cable guide means 2255, 2256, which are stationary with respect to the frame, ensure the rectilinear position thereof outside of the unlocking means 225. They also ensure, when a plurality of cables are present, that they do not touch one another. It is indeed important to prevent contact between cables, so as to limit wear and poor operation due to any friction.

FIGS. 8A and 8B more specifically show the unlocking means 225. FIGS. 9A and 9B are enlarged views of the surrounded portions of FIGS. 8A and 8B respectively.

In the locked position, which is the default position, i.e. when no action is applied by the user and therefore by the unlocking means 225, the carriages 2251 and 2252 are in the position shown in FIGS. 8A and 9A.

In the embodiment shown, two cables 231 and 232 are provided, each integrated with the two bolts 221 and 222. In other embodiments, the cables may be integrated with intermediate elements, connected by connection means to the bolts. It is also possible to provide a single cable. It is also possible for one of the ends of each cable to be connected to the stationary structure of the frame of the mobile panel.

As shown in FIG. 9A, each carriage includes cable passages 241, 242, making it possible to receive the cables 231, 232, allowing for convenient assembly, and to keep them sufficiently separated so as to avoid contact between them.

The carriage also includes a housing 243, intended to receive a finger 244 integrated with an unlocking actuation button or handle 15.

At rest (FIG. 8A), the cables 231 and 232 are aligned. When one acts on the actuation button, or handle 233, the fingers 244 and 245 drive the carriages 2251 and 2252 in directions perpendicular to the axis defined by the two bolts (by means of rails 2253 and 2254).

These movements extend the path of the cables, and consequently bring the bolts 221 and 222 together, which causes the unlocking. When the handle 233 is released, the return springs 234 and 235 respectively associated with the bolts 221 and 222 cause them to return to the locked position shown in FIG. 8A.

FIGS. 10A and 10B diagrammatically summarise the operation of the invention, in the simplified case of a single bolt 221. It is of course easy to generalise it to two bolts, as shown in the previous figures.

At rest, i.e. in the locked position, shown in FIG. 10A, the cable 251 is rectilinear, and its trajectory is not modified by the carriages 2251 and 2252. This cable is connected by one of these ends to the bolts 221 and by the other of these ends to the frame of the mobile panel 252, by means of a return spring 253 for the cable slack.

Pairs of slugs 254, 255 are also provided, formed in the frame of the panel, so as to guide the cable 251, and enable the baffle effect of the cable, and consequently the movement of the bolt, as shown in FIG. 10B.

In this FIG. 10B, the carriages 2251 and 2252 have been moved in opposite directions, driving the cable 251 in a baffle effect, which causes the unlocking of the bolt 221 (arrow 256). A return spring 257 of the bolt acts on the latter, so as to return it to the locked position (FIG. 10A). Thus, when there is no action on the actuation button, the bolt 221 returns to the locked position, similarly pulling the cable 251, which brings the carriages 2251 and 2252, and consequently the actuation button, back to the locked position.

It is possible to provide numerous actuation buttons to act on the carriages 2251 and 2252. An example is shown in FIG. 7. It is also shown, from the outside, in FIGS. 11A and 11B, respectively in a locked position and in an unlocked position. This actuation button includes two pads 261, 262 mounted so as to be capable of rotating about an axis parallel to the cable 251 in the locked position. The fingers 244 and 245 are also moved in rotation according to this axis.

At rest (FIG. 11A), the two pads 261 and 262 are in the same plane, which is advantageously the plane defined by the frame 263 of the panel. To unlock the panel, the user brings the two pads together, as shown in FIG. 11B. The user can then, in the same movement, cause the mobile panel to slide both to the right and to the left (or upward and downward, or in any other direction, according to the embodiment). This technique therefore enables the unlocking and the sliding in the same manipulation.

Other mechanisms for actuating carriages can of course be envisaged, such as translations of the actuation button, or a rotation thereof according to an axis perpendicular to the axis defined by the cable.

In addition, it is noted that the invention can be implemented with a single carriage, or, as the case may be, with more than two carriages, according to the necessary path, in particular.

### 3. Third Embodiment

As shown in FIG. 12, which shows a portion of the frame of the mobile panel, bearing the locking device, the two bolts 321 and 322 are each connected by at least one cable 323, 324 to unlocking means 325.

These unlocking means 325 include a gear system in this case including three gear elements 3251, 3252 and 3253, also called gears, for the purpose of simplification. Gear 3251 is a driving gear, including two gear sections capable of actuating the driven gears 3252 and 3253 in rotation, to which the cables 323 and 324 are connected.

Thus, by actuating the driving gear 3251 in rotation, the driven gears 3252 and 3253 are simultaneously and counter-rotationally driven, and each pull one of the cables, consequently ensuring the unlocking of the bolts 321 and 322.

FIGS. 13A and 13B more specifically show the unlocking means 325, respectively in the locked position and in the unlocked position.

Each driven gear 3252 and 3253 includes, in an offset plane, a pulley element 331, 332 engaging the end of one of the cables (respectively 323 and 324). These elements 331 and 332 advantageously also have an groove for guiding the cable in an arc of a circle, as shown in FIG. 13B.

The rotational movement of these driven gears 3252 and 3253 is ensured by the rotation of the driving gear 3251, of which the movement is controlled by the fingers 333 and 334, which are integrated with the handle or actuation button 335.

As shown in FIG. 12, the cables 323 and 324 are connected by their other end respectively to the bolts 321 and 322. It is understood that, in the position of FIG. 13B, the cables 323 and 324 have been drawn, thereby unlocking the corresponding bolts. More specifically, the movement of the actuation button 335 (arrows 336 and 337) causes, by means of the fingers 333, 334, the movement of the driving gear (arrow 337), and therefore, by means of the driven gears 3252 and 3253, the movement of the cables 323 and 324 (arrows 338 and 339).

The bolts 321 and 322 are associated with return springs that are not shown, which tend to return them to the locked position. Thus, in the absence of any action on the handle 335, these springs act on the cables 323 and 324 so as to return them to the position shown in FIG. 13A. These cables drive the driven gears 3252 and 3253, and therefore successively the driving gear 3251, the fingers 333 and 334, and finally the handle 335. Cable guide elements, not shown, which are stationary with respect to the frame of the mobile panel, can also be provided.

It is also possible to provide numerous actuation buttons to act on the driving gear by means of fingers 333, 334. An example is shown in FIGS. 14A and 14B, respectively in the locked position and in the unlocked position. This actuation button includes two pads 361, 362, mounted so as to be capable of rotating about an axis parallel to the cable in the locked position. The fingers 333 and 334 are also capable of rotating according to this axis.

At rest (FIG. 14A), the two pads 361 and 362 are in the same plane, which is advantageously the plane defined by the frame 363 of the panel. To unlock the panel, the user brings the two pads together, as shown in FIG. 14B. The user can then, in the same movement, cause the mobile panel to slide both to the right and to the left. This technique therefore enables the unlocking and the sliding in the same manipulation.

Other mechanisms for actuating the carriages can of course be envisaged, such as translations of the actuation button, or a rotation thereof according to an axis perpendicular to the axis defined by the cable.

1. Device for locking a sliding panel of a motor vehicle, said panel being mobile with respect to a stationary structure, said device including at least one bolt cooperating with at least one complementary locking element provided for this purpose on said stationary structure, and being capable of moving along a locking axis so as to go from an unlocked state enabling said sliding panel to slide to a locked state in which it cooperates with one of said complementary locking elements so as to prevent said sliding panel to slide, and vice versa,
wherein said locking device comprises manual actioning means acting on said bolt(s), mobile with respect to said sliding panel and capable of adopting at least three positions:
a resting position, in which said bolt(s) is (are) in a locked state with one of said complementary locking elements; and
two unlocking positions, called left and right, in which transmission means act on said bolt(s), said transmission being mounted symmetrically with respect to an axis perpendicular to the sliding axis of said sliding panel, so as to create similar actions on said bolt(s) in each of said locking positions, and to allow, in the same movement of a user:
changing from the resting position to one of said unlocked positions;
sliding movement of said mobile panel in one or the other sliding directions, called right and left, according to the unlocking position selected.

2. Locking device according to claim 1, wherein said actuation means comprise a handle capable of rotating according to an axis substantially perpendicular to the plane defined by said sliding panel,
and wherein said unlocking positions each correspond to a rotation by a predetermined angle with respect to said resting position, respectively in one or the other direction of rotation.

3. Locking device according to claim 2, wherein said handle cooperates with transmission means acting on said bolt(s) and including two connection elements for each of said bolts, wherein a first of said connection elements is active in said left unlocking position, and a second of said connection elements is active in said right unlocking position.

4. Locking device according to claim 3, wherein said actuation means comprise at least one cam actuated by said handle and acting on said connection elements, by means of at least one hole guiding at least one lug integrated with one of said connection elements.

5. Locking device according to claim 4, wherein said hole(s) define(s) an arc of a circle.

6. Locking device according to claim 4, wherein at least one of said cams has, in the vicinity of its periphery, a finger circulating in a hole defined in said handle.

7. Locking device according to claim 1, wherein each of said bolts is integrated with transmission extending substantially in the extension of said locking axis, when said bolt is in said locked state,
and wherein the locking device comprises in that it includes at least one unlocking carriage, mobile in translation along an offset axis substantially perpendicular to said locking axis and substantially parallel to the plane defined by said sliding panel, and acting on said connection means so as to offset them and drive said bolt(s) into said unlocked state.

8. Locking device according to claim 7, wherein each of said unlocking carriages comprises at least one cable passage, in which at least one cable, forming part of said transmission means, can slide.

9. Locking device according to claim 7, wherein each of said unlocking carriages is actuated by a finger integrated with a control button.

10. Locking device according to claim 9, wherein said control button imparts a rotation movement on said finger, according to an axis of rotation substantially parallel to said locking axis.

11. Locking device according to claim 7, comprising two unlocking carriages moving in opposite directions.

12. Locking device according to claim 1, wherein each of said bolts is integrated with a first end of a cable, of which the second end is integrated with a driven gear, driven by a driving gear so as to move said bolt(s) from said locked state to said unlocked state, and
wherein said driving wheel is actuated by an actuation button.

13. Locking device according to claim 12, wherein said driving gear is actuated by at least one finger integrated with said actuation button.

14. Locking device according to claim 13, wherein said actuation button imparts a rotation movement on each of said fingers, according to an axis of rotation substantially parallel to said locking axis.

15. Locking device according to claim 13, wherein said actuation button acts on two fingers moving in opposite directions.

16. Locking device according to claim 12, comprising two bolts, distributed on each side of said driving gear, each associated with a cable and a driven gear.

17. Locking device according claim 12, comprising two bolts, distributed on each side of said actuation button, and two cams respectively associated with one and the other of said bolts, so that said actuation button acts simultaneously and symmetrically on said bolts.

18. Locking device according to claim 17, wherein said cams are mounted on the same axis.

19. Locking device according claim 1, wherein said transmission means belong to the group including cables and rods.

20. Locking device according to claim 19, comprising elements for guiding said cable(s), integrated with said stationary structure.

21. Locking device according to claim 19, wherein the connection means comprises two parallel cables, each connected to the two bolts or respectively by one of their ends to one of the bolts and by the other end to a stationary element.

22. Locking device according to claim 21, comprising means for separating said cables from one another so as to prevent any friction between them.

23. Locking device according to claim 1, wherein each of said bolts cooperates with return means, tending to return them to said locked state.

24. Locking device according to claim 1, wherein said transmission means are connected to said bolt by means for taking up play.

25. Locking device according to claim 1, comprising two bolts, distributed on each side of said locking carriage(s).

26. Closure of a motor vehicle housing, comprising at least one panel capable of sliding, mobile with respect to a stationary structure, comprising a locking device comprising at least one bolt cooperating with at least one complementary locking element provided for this purpose on said stationary structure, and capable of moving along a locking axis so as to go from an unlocked state enabling said sliding panel to slide to a locked state in which it cooperates with one of said complementary locking elements so as to prevent said sliding, and vice versa, and
wherein the locking device comprises means for manual actioning of said bolt(s), mobile with respect to said sliding panel and capable of adopting at least three positions:
a resting position, in which said bolt(s) is (are) in a locked state with one of said complementary locking elements; and
two unlocking positions, called left and right, in which said unlocking positions implement transmission means acting on said bolt(s), which are mounted symmetrically with respect to an axis perpendicular to the sliding axis of said sliding panel, so as to create similar actions on said bolt(s) in each of said locking positions, and to allow, in the same movement of a user:
changing from the resting position to one of said unlocked positions;
sliding movement of said mobile panel in one or the other sliding directions, called right and left, according to the locking position selected.

27. Motor vehicle comprising at least one closure of a motor vehicle housing comprising at least one panel capable of sliding, mobile with respect to a stationary structure, said mobile panel having a locking device comprising at least one bolt cooperating with at least one complementary locking element provided for this purpose on said stationary structure, and capable of moving along a locking axis so as to go from an unlocked state enabling said sliding panel to slide to a locked state in which it cooperates with one of said complementary locking elements so as to prevent said sliding, and vice versa, and
wherein the locking device comprises means for manual actioning of said bolt(s), which are mobile with respect to said sliding panel and capable of adopting at least three positions:
a resting position, in which said bolt(s) is (are) in a locked state with one of said complementary locking elements; and
two unlocking positions, called left and right, in which said unlocking positions implement transmission means acting on said bolt(s), which are mounted symmetrically with respect to an axis perpendicular to the sliding axis of said sliding panel, so as to create similar actions on said bolt(s) in each of said locking positions, and to allow, in the same movement of a user:
changing from the resting position to one of said unlocked positions;
sliding movement of said mobile panel in one or the other sliding directions, called right and left, according to the locking position selected.
